(19) United States
(12) Patent Application Publication
(10) Pub. No.: US 2009/0065665 A1
(43) Pub. Date: Mar. 12, 2009

(54) SCREEN

(75) Inventors: Yasunori Yoshino, Matsumoto-shi (JP); Shinobu Shiohara, Azumino-shi (JP); Masato Maruyama, Matsumoto-shi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/207,396

(22) Filed: Sep. 9, 2008

(30) Foreign Application Priority Data
Sep. 11, 2007 (JP) 2007-235673

(51) Int. Cl. F16M 11/38

(52) U.S. Cl. 248/171

(57) ABSTRACT

A screen includes an image projection section onto which an image light is projected, and a support leg that supports the image projection section. The support leg includes, a support leg body shaped substantially like a pillar, a plurality of leg sections that support upright the support leg body by abutting, at each one end, a placement surface, and a connection member that is attached to the support leg body and connects together the other end of each of the leg sections and the support leg body. The connection member pivotally supports the other end of at least any of the leg sections about a shaft substantially parallel to a vertical shaft.

### BACKGROUND

1. Technical Field

The present invention relates to a screen.

2. Related Art

A previously well-known screen is provided with an image projection section, and a support leg for supporting the image projection section. The image projection section includes a screen body onto which image lights coming from a projector or others are projected with magnification. An example includes Patent Document 1 (Japanese Utility Model Registration No. 3040235).

The support leg of Patent Document 1 is so configured that the image projection section is attached to a column supported upright by three leg sections, thereby supporting the screen in its entirety.

The problem with the screen of Patent Document 1 is that the three leg sections are each disposed at a predetermined angle in a rotation direction about the column. With such a configuration, for using the screen body disposed close to a wall surface, at least any of these three leg sections may bump into the wall surface, thereby resulting in a difficulty in placing the screen body at any desired position proximal to the wall surface. This thus causes a problem of not being able to use the space efficiently.

### SUMMARY

An advantage of some aspects of the invention is to provide a screen offering the efficient use of space.

An aspect of the invention is directed to a screen that includes: an image projection section that includes a screen body onto which an image light is projected; and a support leg that supports the image projection section. In the screen, the support leg includes: a support leg body shaped substantially like a pillar; a plurality of leg sections that support upright the support leg body by abutting, at each one end, a placement surface; and a connection member that is attached to the support leg body, and connects together the other end of each of the leg sections and the support leg body, and the connection member pivotally supports the other end of at least any of the leg sections to be able to rotate about a shaft substantially parallel to a vertical shaft.

In this configuration, at least any of a plurality of leg sections may be pivotally supported by the connection member to be able to rotate about the shaft substantially parallel to the vertical shaft (hereinafter, such a leg section is referred to as rotation leg section). If this is the case, every leg section may be configured as a rotation leg section, or only any one of the leg sections may be configured as a rotation leg section.

In the screen of the aspect of the invention, the support leg is provided with the connection member for connecting the other end of each of the leg sections and the support leg body. The connection member pivotally supports the other end(s) of the rotation leg section(s) to be able to rotate about the shaft substantially parallel to the vertical shaft. As such, by rotating the rotation leg section(s) with respect to the connection member about the shaft substantially parallel to the vertical shaft, the angle can be changed as appropriate between the leg sections in the rotation direction about the support leg body.

Accordingly, if the angle is increased between the leg sections located on the rear surface side of the screen, the degree of protrusion of the leg sections from the screen body to the rear surface side can be reduced, and compared with the previous configuration, the screen body can be thus positioned at any desired position closer to the wall surface.

Moreover, if the angle is increased between the leg sections located on the front surface side of the screen, the degree of protrusion of the leg sections from the screen body to the front surface side can be reduced so that the leg sections may not be obstacles on the front surface side of the screen.

Accordingly, the space can be efficiently used and the advantage of some aspects of the invention can be achieved.

In the screen of the aspect of the invention, preferably, further included are: a fixing member that is fixed to the support leg body on a lower side than the connection member; and a plurality of placement members that are respectively placed across the leg sections and the fixing member. In the screen, the fixing member pivotally supports, to be able to rotate about the shaft substantially parallel to the vertical shaft, one end of any of the placement members connected to the leg section pivotally supported by the connection member about the shaft substantially parallel to the vertical shaft.

In the screen of the aspect of the invention, the support leg is provided with the fixing member and a plurality of placement members. With the fixing member and the placement members provided as such, the support state of the support leg body by the leg sections can be assisted so that the support object can remain stably supported by the support legs.

The fixing member pivotally supports one end of any of the placement members connected to the rotation leg section(s) to be able to rotate about the shaft substantially parallel to the vertical shaft. As such, when the rotation leg section(s) are rotated with respect to the connection member about the shaft substantially parallel to the vertical shaft, the placement members can be moved in response to the rotation of the rotation leg section(s). Accordingly, while keeping stable the support state of a support target by the support legs, the above-described effects of offering the efficient use of space can be achieved in a suitable manner.

In the screen of the aspect of the invention, preferably, the connection member pivotally supports, to be able to rotate via first rotation shafts, the other ends of the leg sections in such a manner that the one ends of the leg sections come close to or move away from a pillar-like shaft of the support leg body, the other end of each of the placement members are pivotally supported by the leg sections to be able to rotate via second rotation shafts respectively being substantially parallel to the first rotation shafts, the fixing member pivotally supports the one end of each of the placement members to be able to rotate via third rotation shafts respectively being substantially parallel to the second rotation shafts, and the connection member is moved along the support leg body in response to rotation of the leg sections and the placement members.

In the screen of the aspect of the invention, the connection member pivotally supports the other ends of the leg sections via the first rotation shafts. As such, by rotating the leg sections with respect to the connection member via the first rotation shafts, the support leg can be changed in state as appropriate, i.e., between a leg-closed state in which one ends of the leg sections are close to a pillar-like shaft of the support leg body (not-in-use state), and a leg-open state in which one ends of the leg sections are away from the pillar-like shaft of the support leg body (in-use state).

Moreover, in the placement members, the other ends are respectively supported pivotally with respect to the leg sections via the second rotation shafts. The fixing member pivotally supports one ends of the placement members via the third rotation shafts. In response to the rotation of the leg sections and the placement members, the connection member moves along the support leg body. As such, because the leg sections and the placement members are coupled to the same connection member, for a state setting of either leg-closed or leg-open, rotating any one of the leg sections with respect to the connection member about any of the corresponding first rotation shafts can rotate also the remaining leg sections with respect to the connection member about the remaining first rotation shafts.

Further, when the state is set in leg-closed, the leg sections and the connection member are moved upward by the placement members compared with the leg-open state. Accordingly, the length of the support leg can be reduced in its entirety when it is not in use, and the resulting support leg can be carried around with ease.

In the screen of the aspect of the invention, preferably, the connection member is provided with a connection member body, and a first rotation shaft support section that pivotally supports the other end of at least any of the leg sections via any of the corresponding first rotation shafts, and is attached to the connection member body to be able to rotate about the shaft substantially parallel to the vertical shaft, and the fixing member is provided with a fixing member body, and a second rotation shaft support section that pivotally supports, via any of the corresponding third rotation shafts, the one end of any of the placement members connected to the leg section pivotally supported by the first rotation shaft support section, and is attached to the fixing section body to be able to rotate about the shaft substantially parallel to the vertical shaft.

In the screen of the aspect of the invention, the connection member is provided with the connection member body, and the first rotation shaft support section that pivotally supports the other end(s) of the rotation leg section(s) via the first rotation shaft(s), and is attached to the connection member body to be able to rotate about the shaft substantially parallel to the vertical shaft. The fixing member is provided with the fixing member body, and the second rotation shaft support section that pivotally supports one end of any of the placement member(s) connected to the rotation leg section(s) via the third rotation shaft(s), and is attached to the fixing member body to be able to rotate about the shaft substantially parallel to the vertical shaft. With such a configuration, the configuration of rotating the rotation leg section(s) can be implemented simply, i.e., rotating the rotation leg section(s) with respect to the connection member about the shaft substantially parallel to the vertical shaft, and also with respect to the connection member but about the first rotation shaft(s). Accordingly, the rotation leg section(s) can be rotated smoothly about the two shafts described above.

In the screen of the aspect of the invention, preferably, the number of the leg sections is four or more.

Herein, when the number of the leg sections is three, the following problem may be caused.

That is, for placing the screen close to the wall surface, the two leg sections located on the rear surface side of the screen are rotated with respect to the connection member about the shaft substantially parallel to the vertical shaft so that the angle between the two leg sections is increased. For the efficient use of the space on the front surface side of the screen, the remaining leg section disposed on the front surface side of the screen is rotated similarly to the above, and is disposed close to the two other leg sections. With such a placement layout, two leg sections are disposed on one side of the screen in the horizontal direction, and only one leg section is disposed on the other side thereof. This thus causes a difficulty in stably keeping the support state of the image projection section.

In the aspect of the invention, because the number of the leg sections is four or more, two or more leg sections are to be disposed on one side of the screen in the horizontal direction, and two or more leg sections are to be disposed on the other side of the screen. This thus enables to keep stable the support state of the image projection section while utilizing the space with good efficiency.

### BRIEF DESCRIPTION OF THE DRAWINGS

The invention will be described with reference to the accompanying drawings, wherein like numbers reference like elements.

FIG. 1 is a perspective view showing the schematic configuration of a screen of an embodiment.

FIG. 2 is another perspective view showing the schematic configuration of the screen of the embodiment.

FIGS. 3A and 3B are each a diagram showing the configuration of an arm member in the embodiment.

FIG. 4 is a diagram showing the configuration of a moving member, that of a pair of coupling members, and that of a biasing member in the embodiment.

FIG. 5 is another diagram showing the configuration of the moving member, that of a pair of coupling members, and that of the biasing member in the embodiment.

FIGS. 6A to 6C are each a diagram for illustrating the operation of an image projection section in the embodiment.

FIG. 7 is another diagram for illustrating the operation of the image projection section in the embodiment.

FIG. 8 is a perspective view showing the schematic configuration of a support leg in the embodiment.

FIG. 9 is a perspective view of the support leg of FIG. 8, viewed from below.

FIG. 10 is an exploded perspective view showing the configuration of a rear-surface-side first pivotal support section in the embodiment.

FIG. 11 is an exploded perspective view showing the configuration of a rear-surface-side second pivotal support section in the embodiment.

FIG. 12 is a diagram for illustrating the operation of the support leg in the embodiment.

FIG. 13 is a diagram showing the schematic configuration of a binding member in the embodiment.

### DESCRIPTION OF EXEMPLARY EMBODIMENTS

### Schematic Configuration of Screen

In the below, an embodiment of the invention is described by referring to the accompanying drawings.

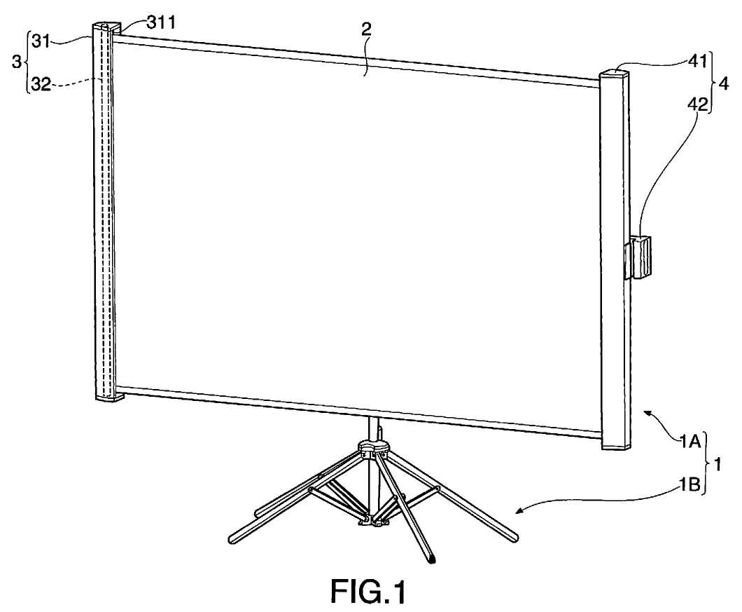

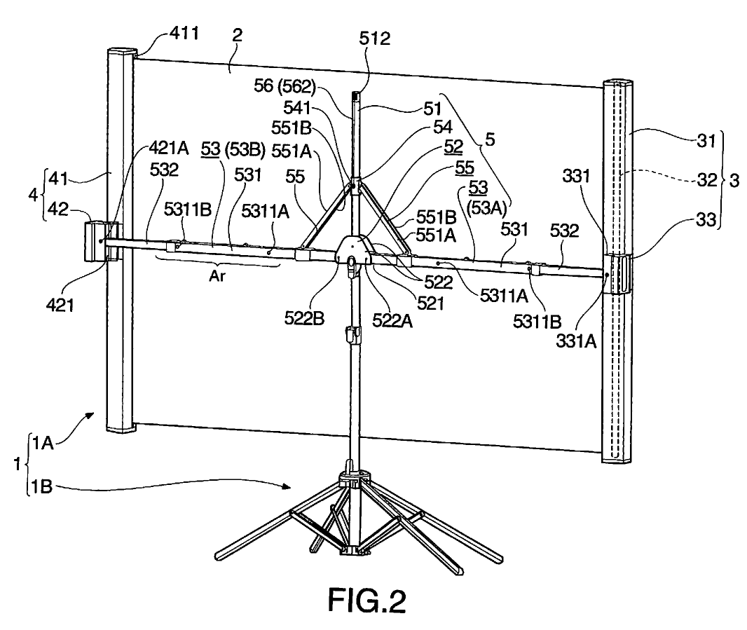

FIGS. 1 and 2 are each a perspective view of a screen 1, showing the schematic configuration thereof. Specifically, FIG. 1 is a perspective view of the screen 1, viewed from the front surface side thereof from which an image light enters. FIG. 2 is a perspective view of the screen 1, viewed from the rear surface side thereof.

Note that the expressions of “right” and “left” in the below denote the right and left sides of the screen 1 when viewed from the rear surface side thereof.

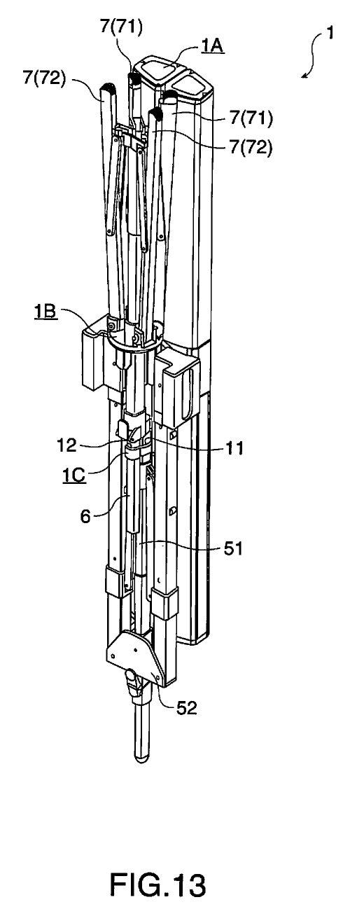

Onto the screen 1, an image light as a result of magnification projection from a projector or others is directed, for example. As shown in FIG. 1 or 2, this screen 1 is mainly configured to include an image projection section 1A, a support leg 1B, and a binding member 1C (refer to FIG. 13).

### Configuration of Image Projection Section

The image projection section 1A is a part where an image light is projected, and as shown in FIG. 1 or 2, is configured to include a screen body 2, a first storage member 3, a second storage member 4, and a retention member 5 (FIG. 2).

The screen body 2 is formed like a sheet with flexibility, and is of a reflection type with which an image light entered to the front side surface thereof is reflected for display.

The first storage member 3 is a portion extending along one of end portions orthogonal to the horizontal direction of the rectangular-shaped screen body 2, i.e., a right end portion, and supporting the right end portion of the screen body 2. As shown in FIG. 1 or 2, the first storage member 3 is configured to include a base body 31, a spring roll 32 serving as a screen take-up section, a first grip section 33 (FIG. 2), and others.

The base body 31 is a chassis shaped substantially like a rectangular parallelepiped extending in the vertical direction, and houses therein the spring roll 32 to be able to rotate.

In such a base body 31, as shown in FIG. 1, the left end surface is formed with an insertion hole 311 for insertion of the screen body 2 to go therethrough.

The spring roll 32 is a member that is configured to be able to rotate about a rotation axis, i.e., the vertical direction of the screen body 2, and takes up the screen body 2. Although not shown specifically, this spring roll 32 is biased by a spring in the direction of taking up the screen body 2, and works to automatically wind up the screen body 2 when the force of pulling out the screen body 2 is reduced.

As shown in FIG. 2, the first grip section 33 is attached to the rear end surface of the base body 31 at substantially the center portion in the vertical direction, and is gripped by a user to move the first storage member 3.

As shown in FIG. 2, this first grip section 33 is formed with a groove section 331 on the side opposing the second storage member 4. This groove section 331 extends from the upper to lower end portions.

The second storage member 4 is a portion extending along the left end portion of the screen body 2, and supporting the left end portion of the screen body 2. As shown in FIG. 1 or 2, this second storage member 4 is configured to include a base body 41, a second grip section 42, and others.

As shown in FIG. 1 or 2, the base body 41 is shaped similar to the base body 31, and supports therein the left end portion of the screen body 2 via an insertion hole 411 (FIG. 2) formed to the right side surface thereof.

As shown in FIG. 1 or 2, the second grip section 42 is shaped similar to the first grip section 33, and is attached to the rear end surface of the base body 41 at substantially the center portion in the vertical direction. The second grip section 42 is a portion where a user grips to move the second storage member 4.

As shown in FIG. 2, this second grip section 42 is formed with a groove section 421 on the side opposing the first storage member 3. The groove section 421 extends from the upper to lower end portions.

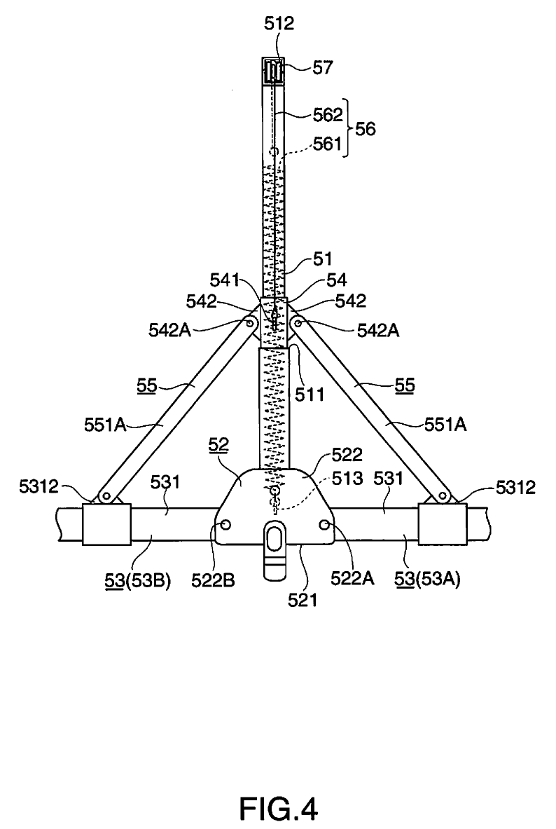

The retention member 5 serves to hold both the first and second storage members 3 and 4. As shown in FIG. 2, this retention member 5 is configured to include a column 51, a joint section 52, a pair of arm members 53, a moving member 54, a pair of coupling members 55, a biasing member 56 (refer to FIG. 4), and others.

As shown in FIG. 2, the column 51 is a substantially cylindrical tube member substantially orthogonal in a direction where the first and second storage members 3 and 4 are opposing, and extends along the screen body 2 in the vertical direction.

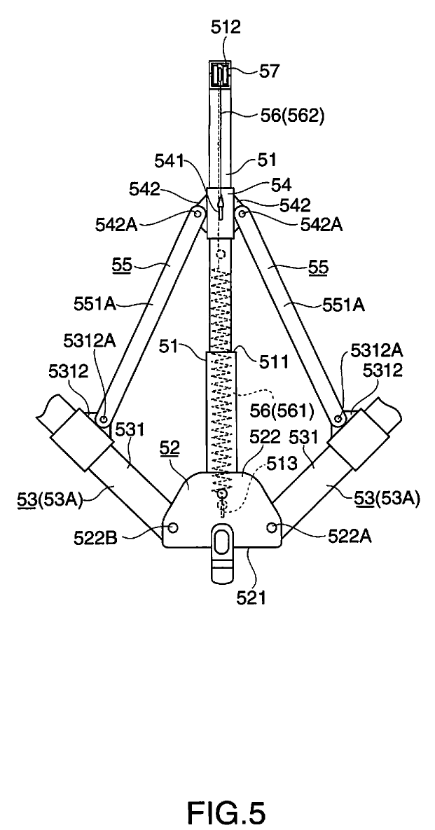

This column 51 is shaped with a width difference, i.e., the lower-side portion thereof is formed larger in diameter than the upper-side portion thereof, and a width-difference section 511 (refer to FIGS. 4 and 5) is provided at substantially the center portion in the vertical direction.

The column 51 is formed with, on its upper end side, a through hole 512 (FIGS. 2, 4, and 5) for insertion of the biasing member 56 to go therethrough, i.e., wire 562 that will be described later. The through hole 512 is formed therein with a pulley 57 for reducing the resistance of the wire 562.

The column 51 is also formed with, on the inner peripheral surface on the lower end side, a first biasing member attachment section 513 (refer to FIGS. 4 and 5). The first biasing member attachment section 513 protrudes toward the inside of the column 51, and is attached with one end of the biasing member 56, i.e., biasing member body 561 that will be described later.

The joint section 52 serves to couple together the column 51 and the arm members 53. As shown in FIG. 2, this joint section 52 is a single-piece configuration including a base section 521 and a pair of protrusion sections 522.

The base section 521 is shaped like a rectangular plate being substantially parallel to the horizontal surface.

The protrusion sections 522 are each shaped like a plate protruding upward from end edges of the base section 521 intersecting in the direction substantially orthogonal to the screen body 2.

Although not shown specifically, in the state that the column 51 is inserted to go through a hole formed at substantially the center portion of the base section 521, the joint section 52 is fixed to the column 51 using a screw or others via the protrusion sections 522.

The joint section 52 is attached with one end of each of the arm members 53 via rotation shafts 522A and 522B (FIGS. 2, 4, and 5) in such a manner that the arm members 53 are symmetrically positioned around the column 51. The rotation shafts 522A and 522B are each substantially orthogonal to the screen body 2 via the protrusion sections 522. That is, one end of each of the arm members 53 are pivotally supported to be able to freely rotate about the rotation shafts 522A and 522B with respect to the joint section 52, i.e., column 51.

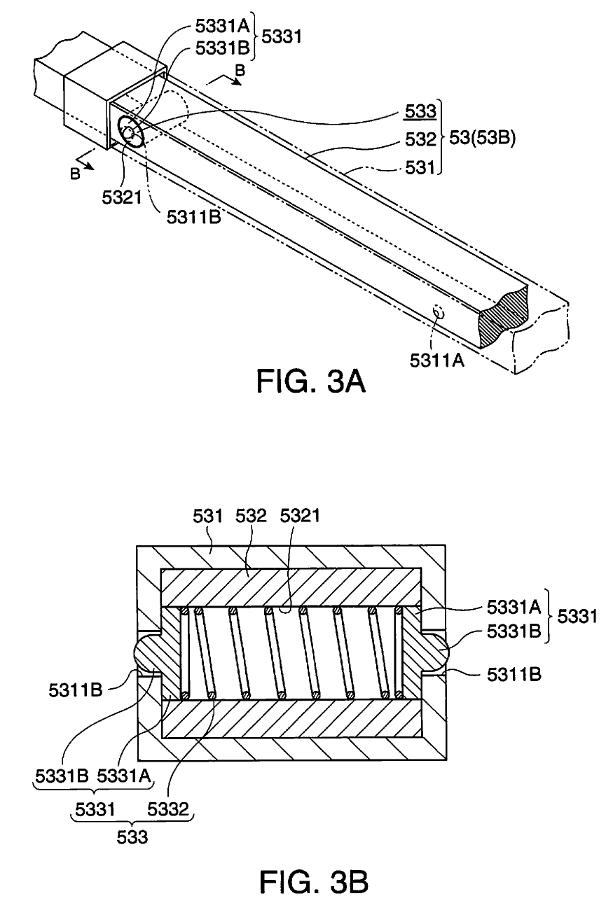

FIGS. 3A and 3B are each a diagram showing the configuration of the arm member 53. Specifically, FIG. 3A shows a part of Ar in FIG. 2. In FIG. 3A, for convenience, a first arm section 531 is partially indicated by chain double-dashed lines, and a second arm section 532 disposed in the first arm section 531 is indicated by solid lines. FIG. 3B is a cross-sectional view of the arm member 53 cut along a line B-B of FIG. 3A.

As shown in FIG. 2, the arm members 53 each serve to couple together the column 51, i.e., joint section 52, and the first and second storage members 3 and 4.

In the below, for convenience, the arm member disposed on the right side is referred to as right-side arm member 53A, and the arm member disposed on the left side is referred to as left-side arm member 53B.

The arm members 53 share the same configuration, and thus described below is only one of the arm members 53.

As shown in FIG. 2 or FIGS. 3A and 3B, the arm member 53 is configured to include the first and second arm sections 531 and 532, a latch member 533 (FIGS. 3A and 3B), and others. The first arm section 531 serves as a tubular member, and the second arm section 532 serves as an insertion section.

As shown in FIG. 2, the first arm section 531 is configured by a tubular member extending in a predetermined direction and being substantially rectangular in cross section. One end of the first arm section 531 is pivotally supported by the joint section 52, i.e., column 51, to be able to freely rotate about the rotation shafts 522A and 522B.

As shown in FIG. 2 or FIGS. 3A and 3B, in the first arm section 531, end surfaces intersecting in the direction substantially orthogonal to the screen body 2 are respectively formed with two latch holes 5311A and 5311B with a predetermined space therebetween in the direction along which the first arm section 531 is extended.

Also in the first arm section 531, on the side of the upper end surface proximal to the coupling portion with the joint section 52, a protrusion section 5312 (refer to FIGS. 4 and 5) is formed by protruding upward.

As shown in FIG. 2 or FIGS. 3A and 3B, the second arm section 532 is shaped like a rectangular prism, and one end side thereof is inserted into the first arm section 531 from the other end side of the first arm section 531, i.e., the end not pivotally supported by the joint section 52. As such, the second arm section 532 is allowed to freely move in the direction along which the first arm section 531 is extended. The other end of the second arm section 531 is coupled to the first storage member 3 (second storage member 4) to be able to rotate about a shaft substantially orthogonal to the screen body 2.

To be specific, as shown in FIG. 2, in the second arm section 532 of the right-side arm member 53A, the other end is inserted into the groove section 331 of the first grip section 33, and then is attached to the first storage member 3 via a rotation shaft 331A substantially orthogonal to the screen body 2. That is, the other end of the right-side arm member 53A is pivotally supported about the rotation shaft 331A to be able to freely rotate with respect to the first storage member 3.

Similarly to the right-side arm member 53A, in the second arm section 532 of the left-side arm member 53B, the other end is inserted into the groove section 421 of the second grip section 42, and is then attached to the second storage member 4 via a rotation shaft 421A.

As shown in FIGS. 3A and 3B, this second arm section 532 is formed with a latch member storage section 5321 that goes through the end surfaces intersecting in the direction substantially orthogonal to the screen body 2, and is circular in cross section for storing therein the latch member 533.

The latch member 533 serves to define the moving position of the second arm section 532 with respect to the first arm section 531. As shown in FIGS. 3A and 3B, this latch member 533 is configured to include a pair of latch member bodies 5331, and a coil spring 5332.

As shown in FIGS. 3A and 3B, the latch member bodies 5331 are similar in shape, and are each a single-piece configuration including a circular plate-like section 5331A, and a latch protrusion section 5331B. The circular plate-like section 5331A is slightly smaller in diameter compared with the latch member storage section 5321. The latch protrusion section 5331B protrudes toward the outside of the surface from the circular plate-like section 5331A to fit in the latch hole 5311A or 5311B. As shown in FIGS. 3A and 3B, the latch member bodies 5331 are both housed in the latch member storage section 5321 in such a manner that their latch protrusion sections 5331B are positioned with a space therebetween.

As shown in FIG. 3B, the coil spring 5332 is housed in the latch member storage section 5321 to be located between a pair of latch member bodies 5331, and biases the latch member bodies 5331 in a direction of moving these away from each other.

With such a configuration, when the second arm section 532 is moved toward/from the first arm section 531, if the latch member 533 housed in the latch member storage section 5321 of the second arm section 532 comes to the position of the latch hole 5311A or 5311B of the first arm section 531, the latch protrusion section 5331B fits in the latch hole 5311A or 5311B, thereby defining the moving position of the second arm section 532 with respect to the first arm section 531.

Herein, the latch member bodies 5331 are being biased by the coil spring 5332, and the tip end portion of the latch protrusion section 5331B is curved. Therefore, even when the latch protrusion section 5331B is fit in the latch hole 5311A or 5311B, with a predetermined level of force applied on the second arm section 532, the second arm section 532 is allowed to move toward/from the first arm section 531.

FIGS. 4 and 5 are each a diagram showing the configuration of the moving member 54, that of the coupling members 55, and that of the biasing member 56.

The moving member 54 is configured by a cylindrical tube member through which the upper-side portion of the column 51 is allowed to be inserted, and as shown in FIG. 4 or 5, moves along the column 51.

As shown in FIG. 2, 4, or 5, the moving member 54 is formed with, on its outer peripheral surface, a second biasing member attachment section 541. This second biasing member attachment section 541 is protruding toward the outside, and is attached with the other end of the biasing member 56, i.e., the end not attached by the first biasing member attachment section 513 (wire 562 that will be described later).

As shown in FIG. 4 or 5, the outer peripheral surface of the moving member 54 is formed with a protrusion section 542 that is protruding toward the outside.

As shown in FIG. 4 or 5, the coupling members 55 are so disposed as to be symmetrical around the column 51, and serve to couple together the moving member 54 and the arm members 53.

Herein, the coupling members 55 share the same configuration, and thus only one of the coupling members 55 is described below.

As shown in FIG. 2, the coupling member 55 is configured by two plate-like members 551A and 551B, which are extending in a predetermined direction.

As shown in FIG. 4 or 5, the two plate-like members 551A and 551B sandwich, between their one ends, the protrusion section 542 of the moving member 54, and in this state, are attached to the protrusion section 542 via a rotation shaft 542A that is substantially orthogonal to the screen body 2. That is, in the coupling member 55, one end is pivotally supported by the moving member 54 to be able to freely rotate about the rotation shaft 542A.

As shown in FIG. 4 or 5, the two plate-like members 551A and 551B also sandwich, between their other ends, the protrusion section 5312 of the first arm section 531, and in this state, are attached to the protrusion section 5312 via a rotation shaft 5312A that is substantially orthogonal to the screen body 2. That is, in the coupling member 55, the other end is pivotally supported by the first arm section 531 to be able to freely rotate about the rotation shaft 5312A.

As shown in FIG. 2, 4, or 5, the biasing member 56 includes the biasing member body 561 (FIGS. 4 and 5), and the wire 562.

The biasing member body 561 is configured by a coil spring, and is disposed inside of the column 51. In the column 51, one end of the biasing member body 561 is attached to the first biasing member attachment section 513 of the column 51, and the other end thereof is connected to one end of the wire 562.

The other end side of the wire 562 is pulled to the outside of the column 51 via the pulley 57 and the through hole 512 formed to the column 51, and then is folded downward from the upper end side of the column 51 for attachment to the second biasing member attachment section 541 of the moving member 54.

With such a configuration, as shown in FIG. 4 or 5, in the biasing member 56, the biasing member body 561 is pulled via the wire 562 when the moving member 54 is moved to the lower side, and by the biasing force of the biasing member body 561, the moving member 54 is biased upward to be away from the joint section 52.

### Operation of Image Projection Section

Described next is the operation of the image projection section 1A described above by referring to the accompanying drawings.

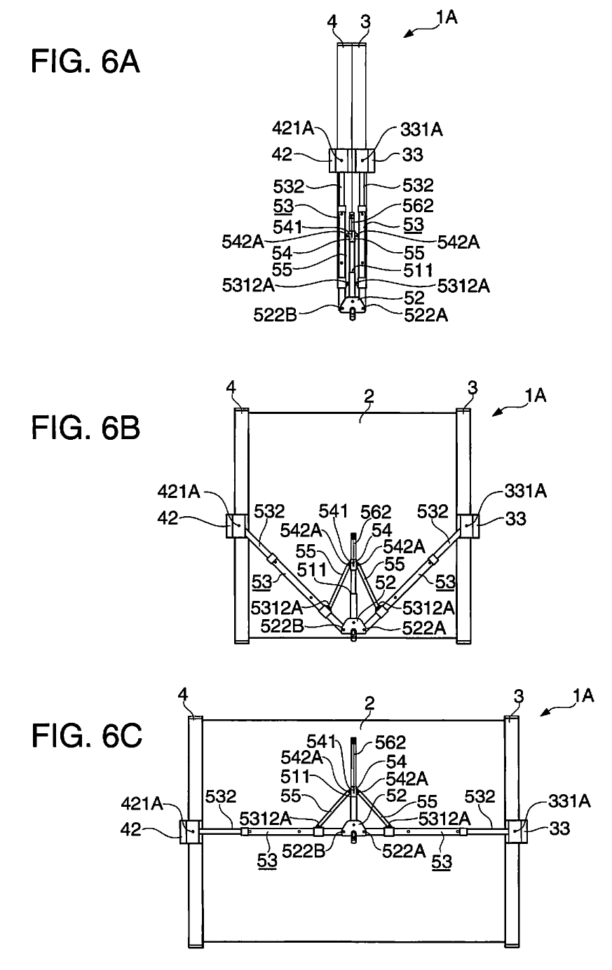

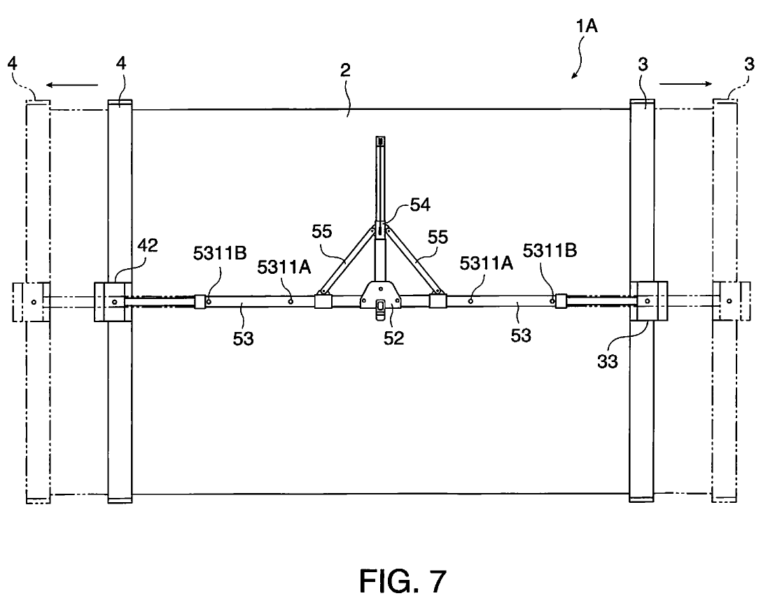

FIGS. 6A to 7 are each a diagram for illustrating the operation of the image projection section 1A. Specifically, FIGS. 6A to 6C are diagrams showing in order the state change of the screen body 2, i.e., from the state of storage in which the screen body 2 is taken up by the spring roll 32 to the state of projection surface formation in which the screen body 2 is pulled out. FIG. 7 is a diagram showing, in the state of projection surface formation of FIG. 6C, that the second arm section 532 is moved toward/from the first arm section 531.

A user applies a force in the direction of moving the first and second storage members 3 and 4 away from each other while gripping both the first and second grip sections 33 and 42. As a result, as shown in FIGS. 6A to 6C, the arm members 53 start rotating about the rotation shafts 522A and 522B with respect to the joint section 52 while rotating about the rotation shafts 331A and 421A with respect to the first and second grip sections 33 and 42. Thereafter, the arm members 53 are changed in state, i.e., from an arm-closed state of FIG. 6A in which the second arm sections 532 are close to each other to an arm-open state of FIG. 6C in which the second arm sections 532 are away from each other so that the first and second storage members 3 and 4 are moved away from each other.

At this time, as shown in FIGS. 6A to 6C, in response to the movement of the arm members 53 as such, the coupling members 55 rotate about the rotation shaft 542A with respect to the moving member 54 while rotating about the rotation shaft 5312A with respect to the arm members 53. The coupling members 55 are then changed in state, i.e., from a coupling-closed state of FIG. 6A in which their other ends, i.e., the ends pivotally supported by the first arm section 531, are close to each other to a coupling-open state of FIG. 6C in which their other ends are away from each other.

Moreover, as shown in FIG. 6A to 6C, in response to the movement of the coupling members 55 as such, the moving member 54 is moved downward along the column 51.

After moving downward, the moving member 54 comes in contact with the width-difference section 511 of the column 51 so that the moving member 54 is restricted in movement. That is, the coupling members 55 and the arm members 53 are all restricted from rotating, and as shown in FIG. 6C, the arm sections 53 are put in the substantially horizontal state. By the first and second storage members 3 and 4 moving away from each other, the screen body 2 is pulled out so that the projection surface is formed. As such, the screen is put in the state of projection surface formation, i.e., image display on the projection surface becomes possible.

Herein, for a state change from the state of 6C, i.e., the state of projection surface formation, to the state of FIG. 6A and 6B, the image projection section 1A operates in reverse order from the order described above.

In the state of projection surface formation of FIG. 6C, when the latch protrusion section 5331B is being fit in the latch hole 5311A, the projection surface of the screen body 2 has the aspect ratio of “4:3” as indicated by the solid lines in FIG. 7. In the state that the second arm section 532 is being pulled out from the first arm section 531, and when the latch protrusion section 5331B is being fit in the latch hole 5311B, the projection surface of the screen body 2 has the aspect ratio of “16:9” as indicated by the chain double-dashed lines in FIG. 7.

That is, the latch holes 5311A and 5311B are respectively formed at the positions where the aspect ratios are “4:3” and “16:9” on the projection surface.

### Configuration of Support Leg

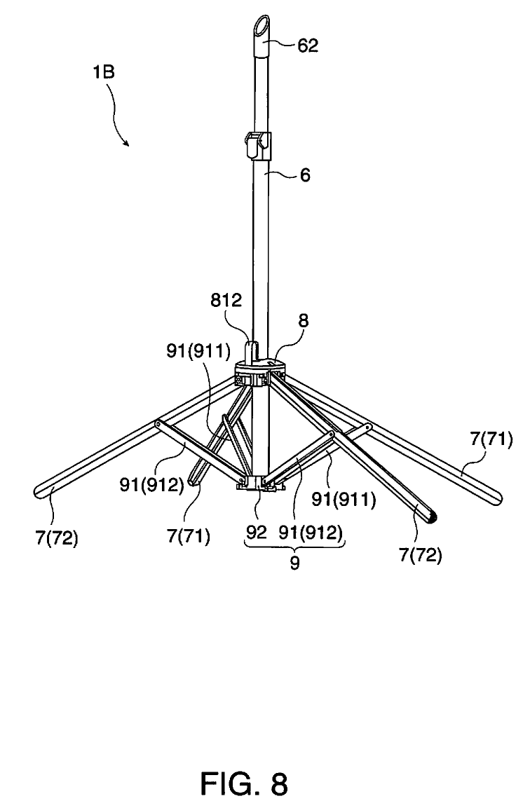

FIG. 8 is a perspective view of the support leg 1B, showing the schematic configuration thereof. Specifically, FIG. 8 is a perspective view of the support leg 1B viewed from the rear surface side of the screen 1.

The support leg 1B is a portion that supports the image projection section 1A, and as shown in FIG. 8, is configured to include a support leg body 6, four leg sections 7, a connection member 8, and a state restriction member 9.

As shown in FIG. 8, the support leg body 6 is a member shaped substantially like a cylinder extending in the vertical direction.

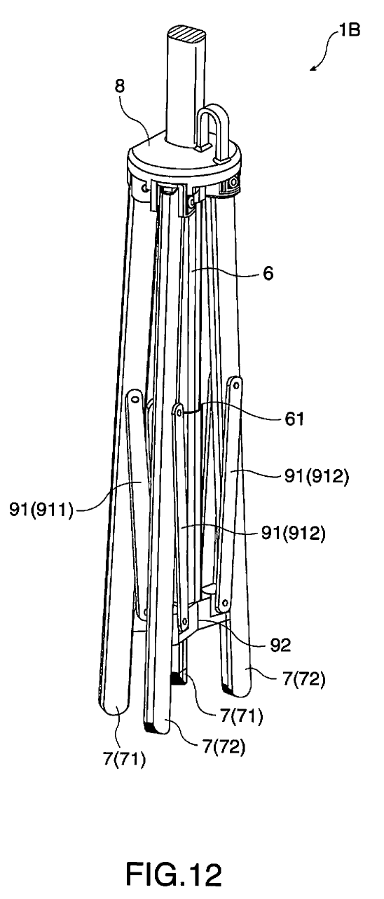

This support leg body 6 is shaped with a width difference, i.e., the lower-side portion thereof is larger in diameter than the upper-side portion thereof, and a width-difference section 61 (refer to FIG. 12) is provided.

In this support leg body 6, as shown in FIG. 8, the upper-side end portion is provided with an attachment/detachment section 62, which is configured by a substantially cylindrical tube member, and is fit with the lower end portion of the column 51. When the lower end portion of the column 51 is fit to the attachment/detachment section 62, the column 51 and the support leg body 6 are connected so that the image projection section 1A is supported by and fixed to the support leg 1B.

As shown in FIG. 8, the four leg sections 7 are each configured by a pillar-like member extending in a predetermined direction, and support upright the support leg body 6 by their one ends abutting the placement surface such as floor surface, and by their other ends being connected to the connection member 8.

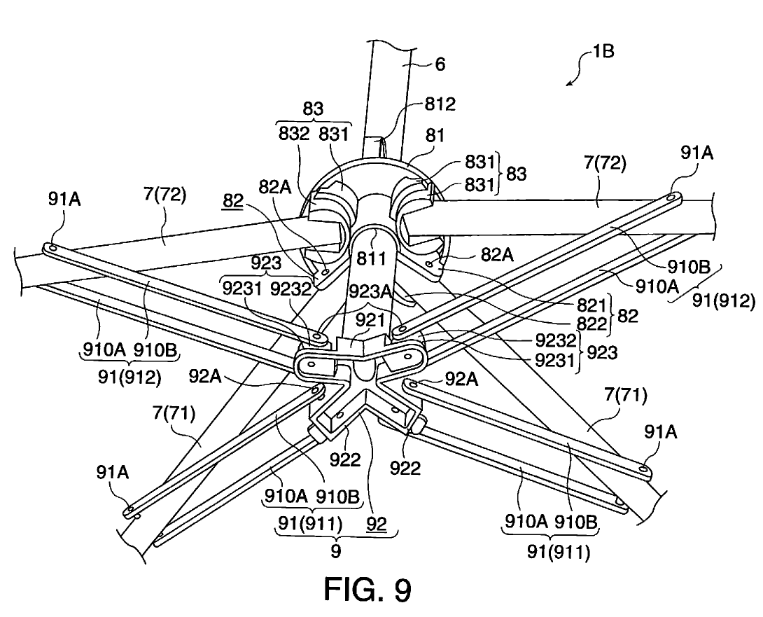

Although specific details will be given later, the four leg sections 7 are so configured as to be changed in state due to the connection structure between their other ends and the connection member 8, i.e., a leg-open state in which their one ends are located away from a pillar-like shaft of the support leg body 6 (in-use state; state of FIGS. 8 and 9), and a leg-closed state in which their one ends are located close to the pillar-like shaft (not-in-use state; state of FIGS. 12 and 13).

Although specific details will be given later, out of the four leg sections 7 due to the connection structure between their other ends and the connection member 8, two are disposed on the front surface side of the screen 1, and are changed in state only between the leg-open state and the leg-closed state, i.e., front-surface-side leg sections 71. The remaining two are disposed on the rear surface side of the screen 1, and are also changed in state between the leg-open state and the leg-closed state, i.e., rear-surface-side leg sections 72. When these rear-surface-side leg sections 72 are in the leg-open state, the angle can be changed with any other leg section 7 adjacent thereto in the direction of rotating about the pillar-like shaft of the support leg body 6.

FIG. 9 is a perspective view of the support leg 1B of FIG. 8 viewed from below.

The connection member 8 moves along the support leg body 6 while being connected with the four leg sections 7. As shown in FIG. 9, this connection member 8 is configured to include a connection member body 81, two front-surface-side first pivotal support sections 82, and two rear-surface-side first pivotal support sections 83.

As shown in FIG. 9, the connection member body 81 is shaped substantially like a disc formed with, at substantially the center portion, an insertion hole 811 for insertion of the upper-side portion of the support leg body 6.

As shown in FIG. 8 or 9, in the connection member body 81, the upper end surface is formed with a handle 812 protruding upward for a user to grip to carry around the support leg 1B.

The two front-surface-side first pivotal support sections 82 are formed on the lower end surface of the connection member body 81 on the front surface side of the screen 1, and pivotally support the other ends of the two front-surface-side leg sections 71, i.e., the ends connected to the connection member 8, to allow their state change between the leg-open state and the leg-closed state.

Herein, the two front-surface-side first pivotal support sections 82 are similar in shape, and thus only one of the front-surface-side first pivotal support sections 82 is described below.

As shown in FIG. 9, the front-surface-side first pivotal support section 82 is configured to include a pair of plate-like sections 821 and 822 protruding downward from the lower end surface of the connection member body 81. The front-surface-side first pivotal support section 82 pivotally supports the front-surface-side leg section 71 via a first rotation shaft 82A while sandwiching the other end of the front-surface-side leg section 71, i.e., the end connected to the connection member 8, to allow its state change between the leg-open state and the leg-closed state.

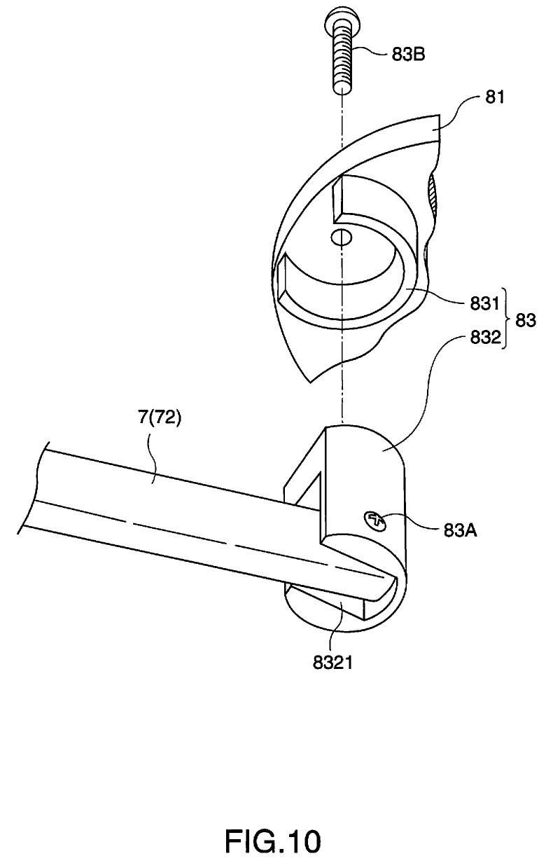

FIG. 10 is an exploded perspective view of the rear-surface-side first pivotal support section 83, showing the configuration thereof.

The two rear-surface-side first pivotal support sections 83 respectively support pivotally the other ends of the two rear-surface-side leg sections 72, i.e., the ends connected to the connection member 8. As shown in FIG. 9 or 10, the rear-surface-side first pivotal support sections 83 are each configured to include a rotation guide section 831, and a first rotation shaft support section 832.

Herein, the two rear-surface-side first pivotal support sections 83 are similar in shape, and thus only one of the rear-surface-side first pivotal support sections 83 is described below.

As shown in FIG. 9 or 10, the rotation guide section 831 is formed on the lower end surface of the connection member body 81 on the rear surface side of the screen 1, and guides the first rotation shaft support section 832 to rotate.

To be specific, as shown in FIG. 10, the rotation guide section 831 protrudes downward from the lower end surface of the connection member body 81, and is shaped like an arc in planar view, i.e., viewed from below, about a vertical shaft corresponding to the outer shape of the first rotation shaft support section 832. The rotation guide section 831 is then fit with the first rotation shaft support section 832, thereby guiding the first rotation shaft support section 832 to rotate.

As shown in FIG. 10, the first rotation shaft support section 832 is configured by a substantially cylindrical member extending in the vertical direction.

This first rotation shaft support section 832 is formed with, at its lower end portion, as shown in FIG. 10, a concave section 8321 for insertion of the other end of the rear-surface-side leg section 72, i.e., the end connected with the connection member 8.

As shown in FIG. 10, for a state change between the leg-open state and the leg-closed state, the first rotation shaft support section 832 pivotally supports the rear-surface-side leg section 72 via a screw 83A, i.e., first rotation shaft, in the state that the concave section 8321 is inserted with the other end of the rear-surface-side leg section 72, i.e., the end connected to the connection member 8.

As shown in FIG. 10, the first rotation shaft support section 832 is attached to the connection member body 81 via a screw 83B, i.e., rotation shaft, from above of the connection member body 81 while being fit to the rotation guide section 831. That is, while being attached to the connection member body 81, the first rotation shaft support section 832 rotates the rear-surface-side leg section 72 about the first rotation shaft 83A for a state change thereof, i.e., between the leg-open state and the leg-closed state. In the leg-open state, the first rotation shaft support section 832 is rotated together with the rear-surface-side leg section 72 about the rotation shaft 83B, i.e., vertical shaft, thereby changing the angle with any other leg section 7 adjacent thereto in the direction of rotating about the pillar-like shaft of the support leg body 6.

When the four leg sections 7 are in the leg-open state, i.e., state of FIG. 8 or 9, the state restriction member 9 serves to restrict the one ends thereof, i.e., the ends abutting the placement surface, not to move away from the pillar-like shaft of the support leg body 6, and to make the four leg sections 7 remain in the leg-open state. As shown in FIG. 8 or 9, this state restriction member 9 is configured to include four placement members 91, and a fixing member 92.

As shown in FIG. 8 or 9, the four placement members 91 are respectively placed across the four leg sections 7 and the fixing member 92.

Herein, these four placement members 91 are similar in shape, and thus only one of the placement members 91 is described below.

As shown in FIG. 9, the placement member 91 is configured by two rod-like members 910A and 910B extending in a predetermined direction.

As shown in FIG. 9, the two rod-like members 910A and 901B sandwich the leg section 7 between their one ends, and in this state, are attached to the leg section 7 via a second rotation shaft 91A, which is parallel to the first rotation shafts 82A and 83A through which thus sandwiched leg section 7 is connected to the connection member 8. That is, one end of the placement member 91 is pivotally supported by the leg section 7 to be able to freely rotate about the second rotation shaft 91A.

In the below, for convenience, among the four placement members 91, two placement members attached to the front-surface-side leg sections 71 are referred to as front-surface-side placement members 911, and two placement members attached to the rear-surface-side leg sections 72 are referred to as rear-surface-side placement members 912.

The fixing member 92 serves to support the four placement members 91. As shown in FIG. 9, this fixing member 92 is configured to include a fixing member body 921, two front-surface-side second pivotal support sections 922, and two rear-surface-side second pivotal support sections 923.

As shown in FIG. 9, the fixing member body 921 is substantially orthogonal to the vertical shaft from the center position, and is shaped substantially like a cross in planar view by protruding in four directions. The center position of the fixing member body 921 is fixed to the lower end portion of the support leg body 6.

As shown in FIG. 9, the two front-surface-side second pivotal support sections 922 are two protruding sections of the fixing member body 921 protruding toward the front surface side of the screen 1. While being sandwiched by the other ends of the rod-like members 910A and 910B, i.e., the ends not sandwiching the leg section 7, the front-surface-side second pivotal support sections 922 pivotally support the other ends of the two front-surface-side placement members 911, i.e., the ends not pivotally supported about the second rotation shaft 91A, via a third rotation shaft 92A, which is parallel to the second rotation shaft 91A through which the front-surface-side placement members 911 are connected to the front-surface-side leg sections 71.

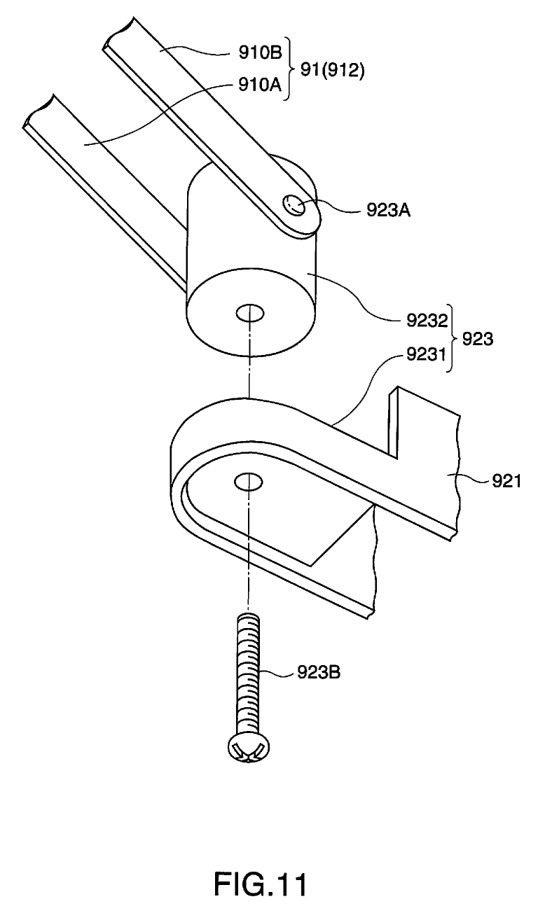

FIG. 11 is an exploded perspective view of the rear-surface-side second pivotal support section 923, showing the configuration thereof.

As shown in FIG. 9, the two rear-surface-side second pivotal support sections 923 are provided to the two protruding sections of the fixing member body 921 protruding toward the rear surface side of the screen 1. These two rear-surface-side second pivotal support sections 923 respectively pivotally support the other ends of the two rear-surface-side placement members 912, i.e., the ends not pivotally supported about the second rotation shaft 91A. As shown in FIG. 9 or 11, the rear-surface-side second pivotal support sections 923 are each configured to include a rotation bearing section 9231, and a second rotation shaft support section 9232.

Herein, these two rear-surface-side second pivotal support sections 923 are similar in shape, and thus only one of the rear-surface-side second pivotal support sections 923 is described below.

As shown in FIG. 11, the rotation bearing section 9231 is shaped like a concave, i.e., recessed downward, at the tip end portions of the protruding sections of the fixing member body 921 protruding toward the rear surface side of the screen 1, and supports the second rotation shaft support section 9232 at the bottom portion thereof.

As shown in FIG. 11, the second rotation shaft support section 9232 is configured by a substantially cylindrical member extending in the vertical direction.

As shown in FIG. 11, the second rotation shaft support section 9232 is sandwiched between the other ends of the rod-like members 910A and 910B, i.e., the ends sandwiching the front-surface-side second pivotal support sections 922, and in this state, pivotally supports the other ends of the rear-surface-side placement members 912, i.e., the ends not pivotally supported about the second rotation shaft 91A, via a third rotation shaft 923A, which is parallel to the second rotation shaft 91A through which the rear-surface-side placement members 912 are connected to the rear-surface-side leg sections 72.

As shown in FIG. 11, the second rotation shaft support section 9232 is supported by the rotation bearing section 9231, and in this state, is attached to the fixing member body 921 via a screw 923B, i.e., rotation shaft, from the lower side of the fixing member body 921. That is, the second rotation shaft support section 9232 is allowed to rotate together with the rear-surface-side placement members 912 about a rotation shaft 923B, i.e., vertical shaft.

### Operation of Support Leg

FIG. 12 is a diagram for illustrating the operation of the support leg 1B. Specifically, FIG. 12 is a perspective view of the four leg sections 7 after a state change to the leg-closed state.

By referring to FIGS. 8, 9, and 12, described next is the operation of the support leg 1B.

In the leg-closed state of FIG. 12, when a user applies a force to the four leg sections 7 in a direction of moving one ends thereof away from the pillar-like shaft of the support leg body 6, the leg sections 7 start rotating about the first rotation shafts 82A and 83A with respect to the connection member 8.

At this time, in response to the movement of the leg sections 7 as such, the four placement members 91 start rotating about the third rotation shafts 92A and 923A with respect to the fixing member 92 while rotating about the second rotation shaft 91A with respect to the leg sections 7. As a result, the leg sections 7, i.e., connection member 8, are pulled downward along the support leg body 6.

After being moved downward, when the connection member 8 comes in contact with the width-difference section 61 of the support leg body 6, the connection member 8 is restricted in movement, and as shown in FIG. 8 or 9, the four leg sections 7 are changed in state, i.e., the leg-open state. In this state, because the four leg sections 7 are placed, by the placement members 91, to the fixing member 92 fixed to the support leg body 6, the four leg sections 7 are restricted to a further degree in movement, i.e., their one ends in the leg-open state are restricted not to move away from the pillar-like shaft of the support leg body 6.

In the leg-open state of FIG. 8 or 9, when the user applies a force to the two rear-surface-side leg sections 72 in a direction of rotating about the pillar-like shaft of the support leg body 6, the rear-surface-side leg sections 72 start rotating together with the first rotation shaft support sections 832 about the rotation shaft 83B.

At this time, in response to the rotation of the rear-surface-side leg sections 72 as such, the two rear-surface-side placement members 912 start rotating together with the second rotation shaft support sections 9232 about the rotation shaft 923B.

This thus changes the angle between any two leg sections 7 in the direction of rotating about the pillar-like shaft of the support leg body 6.

FIG. 13 is a diagram showing the schematic configuration of the binding member 1C.

As shown in FIG. 13, the biding member 1C is a single-piece configuration including first and second tubular sections 11 and 12. The first tubular section 11 is so configured as to be inserted with the upper-side portion of the column 51, and the second tubular section 12 is so configured as to be inserted with the upper-side portion of the support leg body 6.

When the screen 1 is not in use, first of all, as shown in FIG. 13, the image projection section 1A is put in the state of storage. For the purpose, the first tubular section 11 is inserted with the upper-side portion of the column 51, thereby attaching the binding member 1C to the image projection section 1A. Thereafter, as shown in FIG. 13, the support leg 1B is changed in state to the leg-closed state. Also as shown in FIG. 13, in the state that the upper-side portion of the support leg body 6 is proximal to the joint section 52, and in the state that the leg sections 7 are all away from the joint section 52, the upper-side portion of the support leg body 6 is inserted into the second tubular section 12 of the binding member 1C.

As such, when the screen 1 is not in use, the binding member 1C binds together as a piece the column 51 and the support leg body 6 stacked one on the other so that the image projection section 1A and the support leg 1B are combined together.

The embodiment described above can lead to the following effects.

In the above embodiment, the support leg 1B is provided with the connection member 8 for connecting the other end of each of the four leg sections 7 and the support leg body 6. The connection member 8 pivotally supports the other ends of the rear-surface-side leg sections 72 to be able to rotate about the rotation shaft 83B substantially parallel to the vertical shaft. As such, by rotating the rear-surface-side leg sections 72 with respect to the connection member 8 about the rotation shaft 83B, the angle can be changed as appropriate between the rear-surface-side leg sections 72 in the rotation direction about the support leg body 6. Accordingly, if the angle is increased between the rear-surface-side leg sections 72, the degree of protrusion of the rear-surface-side leg sections 72 from the screen body 2 to the rear surface side can be reduced, and compared with the previous configuration, the screen body 2 can be thus positioned at any desired position closer to the wall surface. Accordingly, the space in which the screen 1 is disposed can be used with good efficiency.

The support leg 1B is provided with the four placement members 91 and the fixing member 92. With the placement members 91 and the fixing member 92 provided as such, the support state of the support leg body 6 by the leg sections 7 can be assisted so that the image projection section 1A can remain stably supported by the support leg 1B.

The fixing member 92 pivotally supports one end of each of the rear-surface-side placement members 912 of the four placement members 91 connected to the rear-surface-side leg sections 72 to be able to rotate about the rotation shaft 92B substantially parallel to the vertical shaft. As such, when the rear-surface-side leg sections 72 are each rotated with respect to the connection member 8 about the rotation shaft 83B substantially parallel to the vertical shaft, the rear-surface-side placement members 912 can be moved in response to the rotation of the rear-surface-side leg sections 72. Accordingly, while keeping stable the support state of the image projection section 1A by the support leg 1B, the above-described effects of offering the efficient use of space in which the screen 1 is disposed can be achieved in a suitable manner.

The connection member 8 pivotally supports the other ends of the leg sections 7 via the first rotation shafts 82A and 83A, respectively. As such, by rotating the leg sections 7 with respect to the connection member 8 about the first rotation shafts 82A and 83A, the support leg 1B can be changed in state as appropriate, i.e., between a leg-closed state when the support leg 1B is not in use, and a leg-open state when the support leg 1B is in use.

Moreover, the four placement members 91 are respectively supported pivotally with respect to the leg sections 7 via the second rotation shafts 91A. The fixing member 92 pivotally supports the placement members 91 via the third rotation shafts 92A and 923A, respectively. In response to the rotation of the leg sections 7 and the placement members 91, the connection member 8 moves along the support leg body 6. As such, because the leg sections 7 and the placement members 91 are coupled to the same connection member 8, for a state setting of either leg-closed or leg-open, rotating any one of the leg sections 7 with respect to the connection member 8 about the first rotation shafts 82A and 83A can rotate also the remaining leg sections 7 with respect to the connection member 8 about the first rotation shafts 82A and 83A.

Further, when the state is set in leg-closed, the leg sections 7 and the connection member 8 are moved upward by the placement member 91 compared with the leg-open state. Accordingly, the length of the support leg 1B can be reduced in its entirety when it is not in use, and the resulting support leg 1B can be carried around with ease.

The connection member 8 is provided with the connection member body 81, and the first rotation shaft support section 832 that pivotally supports the other ends of the rear-surface-side leg sections 72 via the first rotation shafts 82A and 83A, and is attached to the connection member body 81 to be able to rotate about the rotation shaft 83B. The fixing member 92 is provided with the fixing member body 921, and the second rotation shaft support section 9232 that pivotally supports one end of any of the rear-surface-side placement members 912 via the third rotation shafts 92A, and is attached to the fixing member body 921 to be able to rotate about the rotation shaft 92B. Accordingly, the configuration of rotating the rear-surface-side leg sections 72 can be implemented simply, i.e., rotating the rear-surface-side leg sections 72 with respect to the connection member 8 about the rotation shaft 83B, and also rotating those with respect to the connection member 8 about the first rotation shafts 82A and 83A, and rotating about the above-described two shafts of the rear-surface-side leg sections 72 can be implemented smoothly.

Herein, because the number of the leg sections 7 is four, two leg sections 7 are to be disposed on one side of the screen in the horizontal direction, and two other leg sections 7 are to be disposed on the other side of the screen 1. This thus enables to keep stable the support state of the image projection section 1A while utilizing the space in which the screen 1 is disposed with good efficiency.

While the invention has been described in detail, the foregoing description is in all aspects illustrative and not restrictive. It is understood that numerous other modifications and variations can be devised without departing from the scope of the invention.

In the above embodiment, a support target to be supported by the support leg 1B is the image projection section 1A. This is surely not restrictive, and any other member such as measuring instrument or camera will also do.

In the above embodiment, two of the four leg sections 7, i.e., the two rear-surface-side leg sections 72, are pivotally supported by the connection member 8 to be able to rotate about the rotation shaft 83A, which is substantially parallel to the vertical shaft. This is surely not the only option, and only one, three, or all of the four leg sections 7 may be configured to be able to rotate about the shaft substantially parallel to the vertical shaft. Considered here is an exemplary configuration in which the front-surface-side leg sections 71 are also allowed to rotate about the shaft substantially parallel to the vertical shaft. In this configuration, by increasing the angle between the front-surface-side leg sections 71 in the direction of rotation about the support leg body 6, the degree of protrusion of the front-surface-side leg sections 71 from the screen body 2 can be reduced, and thus the front-surface-side leg sections 71 will not be obstacles on the front surface side of the screen 1.

In the above embodiment, the number of the leg sections 7 is four, but the number is not specifically restricted, and may be provided five or more.

The support leg according to the embodiments of the invention can offer the efficient use of space, and thus can serve well for supporting an image projection section including a screen body for projection of image lights magnified and projected by a projector or others.

The entire disclosure of Japanese Patent Application No. 2007-235673, filed Sep. 11, 2007 is expressly incorporated by reference herein.

What is claimed is:

1. A screen comprising:
an image projection section onto which an image light is projected; and
a support leg configured to support the image projection section, wherein
the support leg including:
a support leg body shaped substantially like a pillar;
a plurality of leg sections configured to support upright the support leg body by abutting, at each one end, a placement surface; and
a connection member attached to the support leg body, and connects together the other end of each of the leg sections and the support leg body, and
the connection member is configured to pivotally support the other end of at least any of the leg sections about a shaft substantially parallel to a vertical shaft.

2. The screen according to claim 1, further comprising:
a fixing member fixed to the support leg body on a lower side than the connection member; and
a plurality of placement members that are respectively placed across the leg sections and the fixing member, wherein
the fixing member is configured to pivotally support about the shaft substantially parallel to the vertical shaft, one end of any of the placement members connected to the leg section pivotally supported by the connection member about the shaft substantially parallel to the vertical shaft.

3. The screen according to claim 2, wherein
the connection member is configured to pivotally support via first rotation shafts, the other ends of the leg sections in such a manner that the one ends of the leg sections come close to or move away from a pillar-like shaft of the support leg body,
the other end of each of the placement members are configured to pivotally support by the leg sections via second rotation shafts respectively being substantially parallel to the first rotation shafts,
the fixing member is configured to pivotally support the one end of each of the placement members via third rotation shafts respectively being substantially parallel to the second rotation shafts, and
the connection member is configured to move along the support leg body in response to rotation of the leg sections and the placement members.

4. The screen according to claim 3, wherein
the connection member is provided with a connection member body, and a first rotation shaft support section configured to pivotally support the other end of at least any of the leg sections via any of the corresponding first rotation shafts, and is rotatably attached to the connection member body about the shaft substantially parallel to the vertical shaft, and
the fixing member is provided with a fixing member body, and a second rotation shaft support section configured to pivotally support, via any of the corresponding third rotation shafts, the one end of any of the placement members connected to the leg section configured to pivotally support by the first rotation shaft support section, and is rotatably attached to the fixing section body about the shaft substantially parallel to the vertical shaft.

5. The screen according to claim 1, wherein
the number of the leg sections is four or more.
